(19) United States
(12) Patent Application Publication
(10) Pub. No.: US 2015/0048267 A1
(43) Pub. Date: Feb. 19, 2015

(54) Anti cavitation control valve

(71) Applicant: Hans D. Baumann, W. Palm Beach, FL (US)

(72) Inventor: Hans D. Baumann, W. Palm Beach, FL (US)

(21) Appl. No.: 13/987,625

(22) Filed: Aug. 16, 2013

(51) Int. Cl. F16K 47/04

(52) U.S. Cl. CPC F16K 47/04
USPC 251/120

(57) ABSTRACT

An anti-cavitation control valve suitable to reduce high pressure in a fluid control system without creating cavitation or high noise levels, comprising a housing having one fixed and one movable cylinder, both having equally spaced holes that can be opened or closed simultaneously.

The invented device is intended for automatic control applications, and more specifically, for the reduction of high fluid pressures associated with the control of such process variables as volume, temperature, level and pressure of liquid or gaseous fluids.

High pressure reduction of liquids can create excessive sound levels when conventional throttling valves are employed due to a process of cavitation, when part of a liquid can vaporize due to high fluid velocity. A subsequent decrease in velocity downstream of an orifice forces the vapor to collapse, causing very high pressure waves with associated noise.

State of the art devices intended to avoid such annoying or destructive by-products of pressure reduction employ special inserts within valve housings, featuring multiport cages, for example. While moderately effective, they are costly and require larger valve sizes due to the restrictive capacity of such cages. Furthermore, such openings have constant size flow orifices that are unable to adapt to different flow conditions.

Another attempt to accommodate for larger ratios between inlet and outlet pressures in a given system, is to combine a so-called “low noise valve” with a fixed multi-hole plate in a larger downstream pipe. Such systems work well if the volume controlled does not vary by more than two to one, since, at that point, the pressure drop across the plate is reduced by seventy-five percent due to the constant flow area of such plates.

The present invention overcomes these and other limitations of current devices by providing a multi-orifice pressure reduction system, where the opening area of each orifice can vary in unison in response to a change in flow rate. This means that a lower flow rate is accommodated by smaller orifice openings yielding higher frequencies of sound and a higher coefficient of cavitation. Conventional multi-ported cage valves only vary the number of holes exposed to fluid but not their individual dimension.

In addition, my invention can either be operated hydraulically in response to a control signal, or be attached to a reciprocating actuating device of conventional design.

Another great advantage of the invented system is that it can be adapted to any conventional flow control valve, where the pressure in the pipe upstream from the conventional control valve can serve as the hydraulic signal fed into my device. In this case, the conventional control valve only serves to regulate the flow at minimal pressure drop, while the present invention absorbs the bulk of the system pressure.

Yet another advantage of the present invention is that the high pressure jets emanating from holes 6 will impinge on other jets exiting holes on the opposite side of the fixed cylinder, thereby converting their kinetic energy into turbulence and heat without causing harmful erosion of parts of housing 1.

This invention is related to a co-pending patent application under file number Ser. No. 13/507,711.

The above described and other advantages will be better understood in light of the following detailed description.

### BRIEF DESCRIPTION OF THE DRAWING

FIG. 1, shows a central, cross-sectional view of the invention with the flow passages in the closed position.

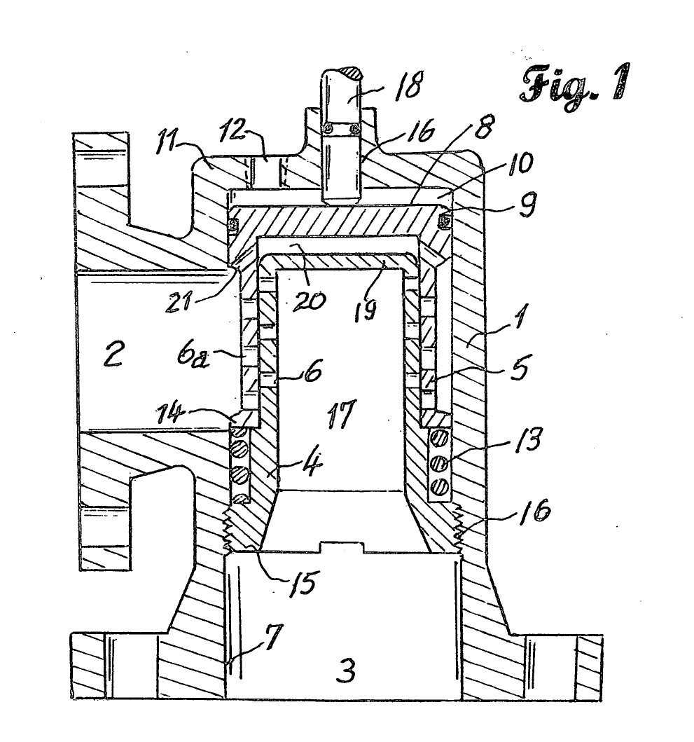

### DETAILED DESCRIPTION OF THE INVENTION

Referring to Figure one, the invention comprises a housing 1 having an inlet port 2 and an outlet port 3. Housing 1 has a vertical central bore 7 containing therein one fixed 4 and one sliding cylinder 5, both being tightly engaged. Both cylinders have a number of equally spaced holes 6, where the holes in the sliding cylinder 6a have a diameter that is ten to twenty percent larger than the holes in the inner fixed cylinder. Fixed cylinder 4 has a lower rim 15 connected by a thread to a similar threaded portion 16 of housing bore 7. A coiled spring 13 is capable of exerting a force against a lower rim 14, being part of sliding cylinder 5,

Housing 1 has a closure 11 of bore 7 containing therein a sensing port 12 and a reciprocating stem 18 capable of being connected to an actuating device of conventional design. Any retraction of stem 18 will cause spring 13 to move sliding cylinder 5 up and cause holes 6 and 6a to overlap and therefore being able to conduct fluid from port 2 to port 3.

Sliding cylinder 5 is closed 8 at its upper terminating end thereby forming a cavity 10 between it and closure 11. This cavity is sealed against hydraulic signal pressure entering through port 12 utilizing o-rings or cup-seals 9.

Fixed cylinder 4 also has an upper closure 19 thereby forming a other cavity 20. Suitable openings 21 allow fluid pressure from inlet port 2 to enter cavity 20 in order to balance forces exerted by hydraulic signal pressure in cavity 10.

The preferred configuration of the perforations are drilled holes, however a number of equally spaced cylindrical slots would serve just as well. The diameter of the holes is determined by aerodynamic noise consideration. Each hole should produce a peak noise frequency in the downstream pipe that is at least twice that of the ring frequency of the pipe. The result is a better sound attenuation, in this case about 13.5 decibel sound reduction compared to a conventional valve having a peak frequency of 0.25 of the pipe's ring frequency, see reference 1. Thus, a preferred hole diameter typically is between two and six percent of the downstream pipe diameter.

It should be understood that during reduced flow, when say, the holes are only one half overlapped, an additional 6 decibel noise reduction is achieved, an important advantage over devices having only fixed openings.

Similar advantages are achieved when the invented device is used for liquids. For example, from the second reference cited, the allowable pressure drop across a throttling device using water as fluid is given as Xfz×(P1−Pv), where P1 is the absolute inlet pressure and Pv is the vapor pressure. In a given example, a single orifice valve, 100 mm in diameter, has an Xfz factor of 0.07, while a multi-ported device having equal flow capacity but 220 equally sized holes, has an Xfz factor of 0.18. This means, the latter can handle 2.5 times the pressure drop that the single-orifice device can, without the fluid commencing to cavitate. This advantageous ratio increases even further when the holes partly overlap.

Additionally, it is advantageous to make the size of the perforations in the sliding cylinder slightly larger than those in the fixed cylinder. The purpose is to compensate for possible misalignment between the two sets of openings and to make sure that the point of maximum velocity of the fluid occurs in the final openings which are located in the fixed cylinder.

Finally, the geometry of two overlapping holes is such, that the open exposed area decreases exponentially in relation to the longitudinal distance between two holes. This yields a relationship between the amount of fluid flow and cylinder travel, commonly known as an equal percentage flow characteristic, a preferred characteristic used for automatic control purposes.

Having thus shown the functions and features of the invention in a preferred embodiment, it should be understood that numerous changes can be made without departing from the scope of the appended claims. One modification could be to add a travel stop to limit the excursions of the piston. Another modification could be to space rows of perforations at different intervals, even though they are spaced identically in both housing and piston. A third choice would be to replace the sliding o-ring seal with a flexible diaphragm placed between the closure 11 and the top of housing 1.

References cited in the description:

1. “Method for estimating of frequency-dependant sound pressure at pipe exterior of throttling valves”. NOISE CONTROL ENGINEERING JOURNAL. Volume 47, Issue 2, March-April 1999, pp. 49-55, Hans D. Baumann

2. “A method to estimate hydrodynamic noise produced in valves by submerged turbulent and cavitating water jets.” NOISE CONTROL ENGINEERING JOURNAL, Volume 52, Number 2, March-April 2004, pp. 40-53, Hans D. Baumann and Joerg Kiesbauer.

1. An anti-cavitation control valve comprising a housing having an inlet and an outlet port extending into a cylindrical bore containing therein one inner fixed and one outer sliding cylinder, each having a number of equally spaced holes capable of conducting fluid from said inlet to said outlet port, said fixed cylinder having a lower rim being suitably fastened to the cylindrical bore of the housing and supporting a coiled spring capable of exerting a force against the lower portion of said sliding cylinder causing the latter to slide up and cause the holes of the inner and outer cylinders to line up in order to conduct fluids from the inlet port to the outlet port.

2. An anti-cavitation control valve as in claim 1, wherein said cylindrical bore has a closure at the terminating upper part of said bore and wherein said sliding cylinder likewise is closed at its upper terminating portion in order to form a cavity between said closure and the top of said sliding cylinder and wherein the terminating upper portion of said sliding cylinder is suitably sealed at its circumference against the surface of said cylindrical bore.

3. An anti-cavitation control valve as in claim 2, wherein said upper closure of said cylindrical bore contains a sensing port capable to conduct an hydraulic pressure signal into said cavity threby causing a downward motion of said sliding cylinder and a compression of said coiled spring.

4. An anti-cavitation control valve as in claim 2, wherein said closure incorporates a sliding stem which, when motivated by an external actuating device, can move said sliding cylinder.

5. An anti-cavitation control valve as in claim 1, wherein the inner bore of said inner cylinder also has an upper closure forming a second void between the inner cylinder closure and the closed portion of said sliding cylinder and wherein said sliding cylinder has suitable openings communicating between the inlet port and said second cavity.

6. An anti-cavitation control valve as in claim 1, wherein the holes in the outer sliding cylinder have a diameter that is between ten and twenty percent larger than the hole diameter in the inner fixed cylinder.
